(19) United States
(12) Patent Application Publication
(10) Pub. No.: US 2026/0342800 A1
(43) Pub. Date: Oct. 29, 2026

(54) User Group Access Permission Automation

(71) Applicant: Gusto, Inc., San Francisco, CA (US)

(72) Inventor: Mohit Ramani, Belleville, NJ (US)

(21) Appl. No.: 19/187,661

(22) Filed: Apr. 23, 2025

(51) Int. Cl. H04L 9/40

(52) U.S. Cl. CPC H04L 63/104; H04L 63/105

(57) ABSTRACT

A central database system identifies a set of roles of the user within an entity. For each role, the system identifies user groups associated with the role. The system automatically provides access permissions to the user to entity resources corresponding to each user group. The system detects a change in the set of roles of the user by querying a role database. The system identifies a first user group associated with a first role that is not associated with the remainder of the set of roles and a second user group associated with a second role that is not associated with the remainder of the set of roles. The system automatically revokes access permissions from the user to entity resources corresponding to the first user group, or automatically provides access permissions to the user to entity resources corresponding to the second user group.

### FIELD OF DISCLOSURE

This disclosure relates generally to automated permission management systems, and more specifically to systems and methods for dynamically managing user roles and access permissions in database environments based on role changes within an organization.

### BACKGROUND

Entities often use central database systems to manage access to various resources within their organization. These resources may include sensitive data, applications, tools, or other digital assets that require controlled access through role-based access control systems. Traditional systems require manual intervention to modify user permissions when roles change within an organization. This manual process requires multiple database queries and updates across various system components, leading to increased computational overhead and network traffic. For example, when an employee changes departments, administrators must execute multiple database operations to identify current permissions, revoke outdated access rights, and grant new permissions, consuming unnecessary computational resources and network bandwidth.

Furthermore, the delay between role changes and permission updates creates temporary inconsistencies in the database system, requiring additional computing resources for reconciliation processes and validation checks across distributed system components. The system must maintain multiple temporary states and execute additional verification queries to ensure permission integrity during the transition period, leading to increased database load and system latency. This inefficient approach impacts system performance and creates security vulnerabilities, requiring continuous resource-intensive verification processes to identify and log potential security breaches during transition periods.

### SUMMARY

An automated role-based access management system dynamically updates user permissions across enterprise resources by detecting role changes and efficiently managing corresponding access rights through a centralized database system. In some embodiments, a central database system automatically detects role changes and efficiently manages corresponding access permissions across enterprise resources without manual intervention. For example, when a user's role changes within an organization, the system automatically identifies affected user groups, determines which access permissions should be revoked or granted based on the role change, and updates the permissions accordingly. The system maintains an entitlement dataset that maps roles to user groups and corresponding resource permissions, allowing efficient permission updates through a single database operation rather than multiple redundant queries. This automated approach reduces computational overhead by eliminating the need for repeated permission verification processes and minimizes database inconsistencies during role transitions.

In accordance with one or more aspects of the disclosure, a central database system identifies a set of roles of the user within an entity. For each role, the system identifies one or more user groups associated with the role. The system automatically provides access permissions to the user to entity resources corresponding to each user group associated with the set of roles. The system detects a change in the set of roles of the user by querying a role database maintained by the central database system. The detected change includes a first role that is removed from the set of roles of the user and a second role that is added to the set of roles of the user. The system identifies a first user group associated with a first role that is not associated with the remainder of the set of roles and a second user group associated with a second role that is not associated with the remainder of the set of roles. The system automatically revokes access permissions from the user to entity resources corresponding to the first user group, and/or automatically provides access permissions to the user to entity resources corresponding to the second user group.

### BRIEF DESCRIPTION OF THE DRAWINGS

FIG. 1 is a block diagram illustrating a system environment of a central database system, in accordance with an embodiment.

FIG. 2 is a block diagram illustrating an access management module, in accordance with an embodiment.

FIG. 3 illustrates an example of a workflow for performing permission updates on a system, in accordance with an embodiment.

FIG. 4 is a flowchart illustrating a process for permission management, in accordance with an embodiment.

### DETAILED DESCRIPTION

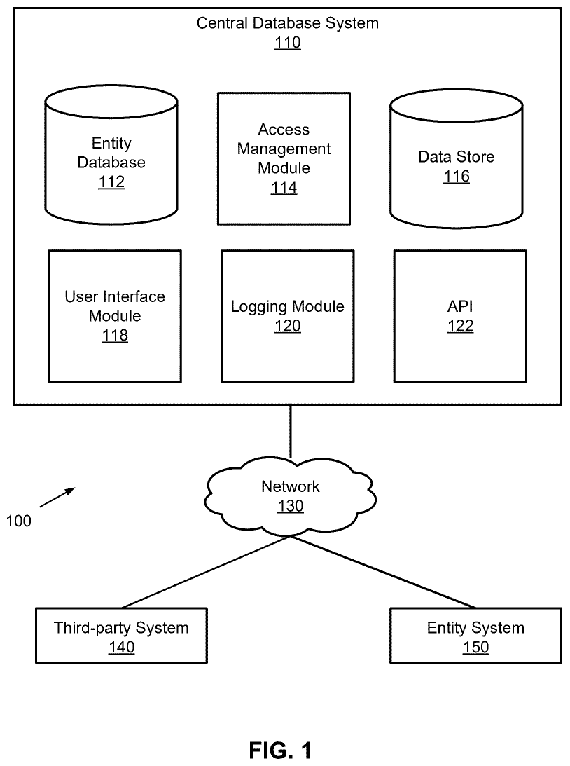

FIG. 1 is a block diagram illustrating a system environment of a central database system, in accordance with an embodiment. The system environment 100 shown in FIG. 1 includes a central database system 110, a network 130, one or more third-party systems 140, and one or more entity systems 150. The system environment 100 may have alternative configurations than what is illustrated in FIG. 1, including different, fewer, or additional components.

The central database system 110 is configured to manage access permissions to entity resources when an entity system 150 sends user role information through the network 130. The central database system 110 processes this information by identifying user roles within the entity system 150, mapping these roles to appropriate user groups, and automatically providing or revoking access permissions to entity resources based on the user's group memberships. The central database system 110 may also interface with one or more third-party systems 140 (e.g., human resource information systems, identity providers, or other enterprise systems) to obtain additional user information or to propagate permission changes across multiple platforms.

The central database system 110 continuously monitors for changes in user roles by querying relevant databases and automatically updates access permissions when changes are detected. When a role change is identified, the central database system 110 determines which user groups are uniquely associated with the removed and added roles, then automatically revokes or grants the corresponding access permissions. Throughout this process, the central database system 110 maintains detailed logs of all permission changes, performs anomaly detection on group membership changes, and may halt automated updates for manual review when significant changes are detected, providing secure and controlled access management across the entity's resources.

In the embodiment shown in FIG. 1, the central database system 110 includes an entity database 112, an access management module 114, a data store 116, a user interface module 118, a logging module 120, and an application programming interface (API) 122. It should be noted that in other embodiments, the central database system 110 can include fewer, additional, or different components than those illustrated herein. In the embodiment of FIG. 1, the central database system 110 is associated with a human resources management entity different from the one or more third-party systems 140 and from the one or more entity systems 150. Accordingly, the central database system 110 includes hardware (such as servers, networking equipment, databases or other storage devices, data center systems, and the like) distinct (and in some embodiments, physically remotely from) the one or more third-party systems 140 and the one or more entity systems 150.

The entity database 112 is configured to store and manage current operational information associated with users and roles within the one or more entity systems 150 to facilitate real-time access permission management via the central database system 110. For each entity system 150, the entity database 112 maintains active entries containing current user data such as role information, organizational hierarchies, and employment status. The entries include current role-related information such as role identifiers, role descriptions, role hierarchies, role dependencies, and current user group information including group identifiers, group descriptions, group hierarchies, and active mappings between roles and associated user groups. The entity database 112 serves as the primary source for day-to-day permission management operations and real-time access control decisions.

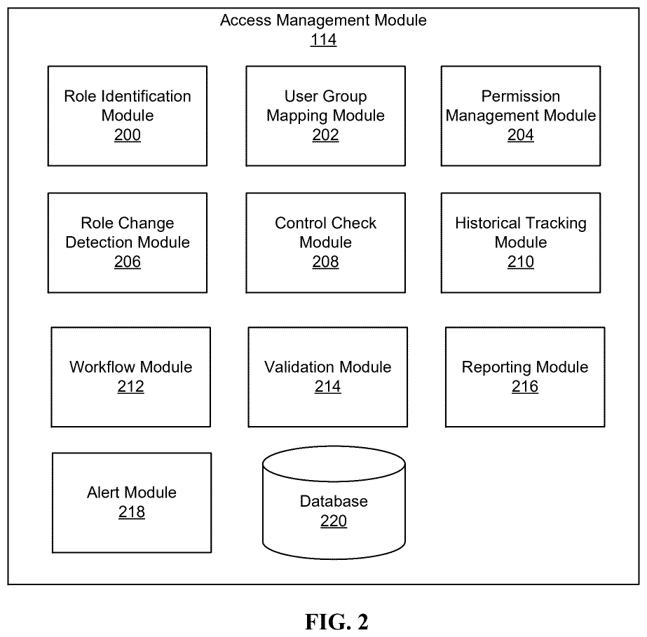

The access management module 114 manages user access permissions to entity resources by automatically processing role changes and updating corresponding access rights. The access management module 114 may include several components as discussed with respect to FIG. 2. The access management module 114 maintains an entitlement dataset that maps roles to user groups with associated timestamps, and interfaces with the entity database 112 to retrieve user and role information. When role changes are detected, the access management module 114 automatically revokes or grants access permissions based on the user's updated role assignments while maintaining detailed logs of all permission modifications. The access management module 114 may also halt automated updates, for example, when significant changes are detected to provide manual review of the changes.

The entity resources may be stored in various locations within the system environment 100. In some embodiments, the entity resources are stored within the entity systems 150 themselves, such as in local databases or servers maintained by each entity. In other embodiments, the entity resources are stored in one or more third-party systems 140, such as cloud storage providers or software-as-a-service platforms. In some embodiments, the entity resources may be stored within the central database system 110 (e.g. the entity database 112, the data store 116, etc.), particularly when the central database system 110 provides direct services to the entity systems 150. In some embodiments, the entity resources are distributed across multiple locations, with some resources stored locally at entity systems 150, others maintained by third-party systems 140, and still others hosted within the central database system 110. The API interface 122 of the central database system 110 can provide unified access permission management regardless of where the entity resources are physically stored.

The data store 116 is configured to store and manage historical and analytical data used by the central database system 110 for permission management analysis and auditing. The data store 116 maintains historical records of all changes to user roles, group memberships, and access permissions over time, providing pattern detection and trend analysis. In some embodiments, the data store 116 serves as an analytical repository for tracking changes in roles, permissions, and group memberships, supporting complex queries for audit trails, compliance reporting, and anomaly detection. The data store 116 may also store aggregated metadata about user interactions with entity resources, access patterns, and usage statistics to support sophisticated analysis and reporting functions. The entity database 112 and the data store 116 can work together to provide permission management features. While the entity database 112 handles real-time permission decisions using current data, it continuously feeds updates and changes to the data store 116 for historical tracking and analysis. The data store 116, in turn, provides historical context and analytical insights that can inform the access management module 114's decision-making processes, particularly for anomaly detection and audit purposes. This dual-database architecture allows the central database system 110 to maintain both high-performance real-time operations and historical analysis capabilities.

The user interface module 118 coordinates communications between the entity systems 150 and third-party systems 140, and can generate one or more graphical user interfaces (GUIs) of the central database system 110 for display by devices of the entities 150 and third-party systems 140. The GUIs allow the entity systems 150 and third-party systems 140 to provide information to the central database system 110, view information stored by the central database system 110, and interact with various system features. The user interface module 118 allows administrators to view and manage access permissions, monitor role changes, and review permission-related alerts through various interface elements. When the central database system 110 detects anomalous changes in group memberships or permissions, it may generate a GUI through the user interface module 118 to display the detected anomalies and provide interface elements that allow administrators to review and approve or reject the changes. The user interface module 118 also provides interactive dashboards for viewing historical permission changes, accessing audit logs, and generating access-related reports. Additionally, the user interface module 118 can include elements for manually managing user roles, configuring role-to-group mappings, and setting up control check parameters that govern automated permission management processes.

The logging module 120 maintains audit trails of all permission-related activities within the central database system 110, storing the logs in the data store 116. The logging module 120 records events including role changes, permission updates, group membership modifications, and administrative actions taken through the user interface module 118. When anomalous changes are detected by the access management module 114, the logging module 120 captures details about the anomalies and subsequent administrative actions. The logs include timestamps, user identifications, affected resources, and the nature of each change, enabling administrators to access historical records through the user interface module 118 for auditing, compliance reporting, and issue investigation. The logging module 120 can also generate alerts when some changes or patterns are detected in the permission management system.

The API 122 allows interactions between the central database system 110 and entity resources, regardless of where these resources are physically stored. For example, the API 122 provides interfaces for managing access permissions across resources stored within the entity systems 150, third-party systems 140, or the central database system 110. When the access management module 114 needs to update permissions, the API 122 executes the necessary calls to add or revoke access rights across the distributed resources. Further, the API 122 supports integration with various authentication and authorization protocols to provide secure access management across different systems and platforms.

The central database system 110, the one or more third-party systems 140, and the one or more entity systems 150 are configured to communicate via the network 130, which may comprise any combination of local area and/or wide area networks, using wired and/or wireless communication systems. In one embodiment, the network 130 uses standard communications technologies and/or protocols. For example, the network 130 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 130 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 130 may be represented using any suitable format, such as hypertext markup language (HTML) or extensible markup language (XML). In some embodiments, all or some of the communication links of the network 130 may be encrypted using any suitable technique or techniques.

The third-party system 140 is a service provider configured to provide user, entity, and/or role information to the central database system 110. The central database system 110 may integrate with or subscribe to the third-party system 140. In some embodiments, the third-party system 140 may be a human resources information system (HRIS) that provides employee data, role information, and organizational hierarchies to the central database system 110. In other embodiments, the third-party system 140 may be an identity provider, cloud storage provider, or software-as-a-service platform that maintains entity resources and user authentication information. The third-party system 140 may also include enterprise systems that the central database system 110 needs to coordinate with for access permission management across an organization's technology infrastructure.

The entity system 150 represents the computing infrastructure of a company or organization that interfaces with the central database system 110 for access permission management. The entity system 150 communicates with the central database system 110 using various devices such as computer systems (e.g., desktop computers, laptop computers, servers, cloud computing devices), client devices (e.g., smartphones, tablet computers, mobile devices), or any other devices with computer functionality. The entity system 150 is configured to communicate with the central database system 110 and third-party systems 140 via the network 130, either through native applications executed by the devices or through APIs. The entity system 150 maintains various resources that require controlled access management. These resources may be stored locally within the entity system 150 (e.g., in local databases or servers), in third-party systems 140 (e.g., cloud storage providers), within the central database system 110 (e.g., the entity database 112, the data store 116), or distributed across multiple locations. The entity system 150 integrates with the central database system 110′s permission management infrastructure through the API 122 to ensure secure and automated access control across its resources, regardless of where they are physically stored.

FIG. 2 is a block diagram illustrating the access management module 114 of FIG. 1. The access management module 114 includes a role identification module 200, a user group mapping module 202, a permission management module 204, a role change detection module 206, a control check module 208, a historical tracking module 210, a workflow module 212, a validation module 214, a reporting module 216, an alert module 218, and a database 220. The access management module 114 may have alternative configurations than what is illustrated in FIG. 2, including different, fewer, or additional components.

The role identification module 200 identifies a set of roles for users within an entity system 150. The role identification module 200 queries the entity database 112 and/or data store 116 to retrieve user data associated with each user and analyzes this data to determine role data segments associated with the user. The role identification module 200 applies predefined logic rules to these role data segments, determines whether the segments satisfy criteria defined in the logic rules, and identifies the set of roles that correspond to satisfied criteria. For example, a predefined logic rule may specify that users with “Manager” in their business title and who belong to the “Finance” department should be assigned the “Finance Manager” role, or that employees with a job level above L5 and in the “Engineering” organization should be assigned the “Senior Engineer” role. The role identification module 200 may analyze multiple user characteristics such as business title, job profile, organizational position, reporting relationships, cost center, employment type (regular vs. contingent), and job level to determine their roles within the entity system 150. If these characteristics satisfy the criteria defined in the logic rules (e.g., title contains specific keywords, job level exceeds certain thresholds, or multiple conditions are met simultaneously), the corresponding roles are assigned to the user. The role data identified by the role identification module 200 can be used for subsequent permission management operations by other components of the access management module 114.

The user group mapping module 202 identifies one or more user groups associated with each role of the user. The user group mapping module 202 maps roles to their associated user groups using an entitlement dataset maintained in the database 220. The entitlement dataset is a structured data collection that maintains relationships between roles and user groups, including elements such as mapping IDs, role information, group information, timestamps, and mapping metadata. The user group mapping module 202 queries the entitlement dataset using role identifiers to retrieve user group associations for each role. A role identifier uniquely identifies a role within the entity system 150 (e.g., “FINANCE_MANAGER_ROLE_001” for a Finance Manager role, “SR_ENGINEER_ROLE_002” for a Senior Engineer role). Similarly, group identifiers uniquely identify user groups (e.g., “FINANCE_DASHBOARD_GROUP_001” for a Finance Dashboard access group, “ENG_TOOLS_GROUP_002” for an Engineering Tools access group). User group associations define which groups are linked to specific roles (e.g., the Finance Manager role is associated with both the Finance Dashboard group and the Budget Approval group).

The user group mapping module 202 maintains role-to-group mappings that define these relationships (e.g., “FINANCE_MANAGER_ROLE_001” maps to [“FINANCE_DASHBOARD_GROUP_001”, “BUDGET_APPROVAL_GROUP_003”]). These role-to-group associations are tracked with timestamps (e.g., “2025-01-17T10:30:00Z”) to maintain a historical record of when associations were created, modified, or removed. When querying the entitlement dataset, the user group mapping module 202 identifies the current timestamp (the system's current date and time) and filters the dataset to retrieve only currently active mappings.

The user group mapping module 202 maintains metadata indicating whether each mapping is manually maintained (explicitly defined by administrators through the user interface module 118) or automatically inferred (determined by the system based on predefined rules, such as automatically mapping all users with “Manager” titles to their respective department's management groups). The user group mapping module 202 stores timestamps associated with each role-to-group mapping, tracks changes to these associations over time, and maintains historical records of all mappings in the data store 116.

The permission management module 204 automatically provides access permissions to users for entity resources corresponding to each user group associated with their roles. The permission management module 204 manages access permissions by maintaining an access dataset in the database 220 that defines the relationships between user groups and entity resources. The permission management module 204 retrieves resource identifiers that uniquely identify each entity resource (e.g., “FINANCE_DASHBOARD_001” for a financial reporting dashboard, “HR_DATABASE_002” for an HR database, “CODE_REPO_003” for a code repository). The permission management module 204 determines access levels assigned to each group for these resources, where access levels define the degree of permission (e.g., “READ_ONLY”, “READ_WRITE”, “FULL_ACCESS”, “ADMIN”).

The access dataset maintained by the permission management module 204 contains various elements including: resource IDs, group IDs, permitted operations, access levels, and timestamps. The permission management module 204 maps user groups to permitted operations on entity resources (e.g., the Finance Dashboard group is mapped to [“VIEW”, “EXPORT”, “SHARE”] operations on financial reports). Based on these mappings, the permission management module 204 identifies the permitted operations of each user group (e.g., members of the Engineering Tools group can “READ”, “WRITE”, and “EXECUTE” on development resources) and assigns corresponding access rights (e.g., grants “READ_WRITE” access level based on the permitted “READ” and “WRITE” operations).

When executing permission updates, the permission management module 204 implements specific changes through the API 122 (e.g., granting “READ_WRITE” access to a new Finance Manager on financial dashboards, revoking “ADMIN” access from a former HR Manager on personnel databases). These permission updates are automatically executed across all entity resources, whether stored in entity systems 150 (e.g., local databases), third-party systems 140 (e.g., cloud services), or the central database system 110. The permission management module 204 interfaces with the logging module 120 to maintain audit trails of all permission changes in the data store 116.

The role change detection module 206 detects changes in user roles by monitoring and querying a role database maintained in the database 220. The role database is a structured dataset that maintains role information of entity users. The role information can include role identifiers, role titles, role status (active/inactive), role assignments, role hierarchies, and timestamps. For example, the role database may include entries such as {role_id: “FINANCE_MANAGER_001”, user_id: “EMP123”, status: “active”, assignment_date: “2025-01-01”} for current roles and historical entries showing previous role assignments.

The role change detection module 206 receives trigger events indicating potential role changes. These trigger events can originate from various sources, such as: HR system updates (e.g., job title changes, department transfers), organizational hierarchy changes (e.g., reporting relationship updates), direct manager requests (e.g., role reassignments), or automated system detection of employment status changes (e.g., promotions, transfers, terminations). For example, a trigger event may be generated when an employee transfers from the Finance department to HR, triggering a role change from “Finance Analyst” to “HR Analyst.”

When the role change detection module 206 receives a trigger event, it queries the role database to retrieve current role information for the user. The role change detection module 206 retrieves historical role information from the role database and compares it with current role information to identify changes. For example, the role change detection module 206 may detect that user “EMP123” previously had the role “FINANCE_MANAGER_001” but now has “HR_MANAGER_002”, identifying the first role (removed) and second role (added). The role change detection module 206 maintains audit trails of these detected role changes in the data store 116 and initiates permission update processes through the permission management module 204 or the workflow module 212 when role changes are detected.

Responsive to detection of a role change, the permission management module 204 identifies a first user group associated with the first role that is not associated with a remainder of the set of roles and a second user group associated with the second role that is not associated with the remainder of the set of roles. For example, if a user's set of roles initially includes [“Finance Manager”, “Budget Reviewer”, “Report Editor”], and the user transitions from Finance to HR, the first role (removed) may be “Finance Manager” while the second role (added) may be “HR Manager”, leaving the remainder of the set of roles as [“Budget Reviewer”, “Report Editor”].

The permission management module 204 performs these identifications by analyzing the user group mappings. In some embodiments, the permission management module 204 identifies the first user group by maintaining a user group dataset that maps roles to associated user groups (e.g., “Finance Manager” maps to [“Finance_Dashboard_Group”, “Finance_Data_Group”]), querying the user group dataset to retrieve user groups mapped to the first role, and querying the user group dataset to retrieve user groups mapped to the remainder of the set of roles. The permission management module 204 then identifies the first user group as a user group that is mapped to the first role and not mapped to any role in the remainder of the set of roles (e.g., “Finance_Data_Group” is unique to the “Finance Manager” role and not associated with “Budget Reviewer” or “Report Editor”).

In a corresponding manner, the permission management module 204 identifies the second user group by maintaining the user group dataset, querying the user group dataset to retrieve user groups mapped to the second role (e.g., “HR Manager” maps to [“HR_Dashboard_Group”, “Personnel_Data_Group”]), and querying the user group dataset to retrieve user groups mapped to the remainder of the set of roles. The permission management module 204 then identifies the second user group as a user group that is mapped to the second role and not mapped to any role in the remainder of the set of roles (e.g., “Personnel_Data_Group” is unique to the “HR Manager” role). Throughout this process, the permission management module 204 maintains audit trails of group identification activities in the data store 116.

The permission management module 204 automatically revokes access permissions from the user to entity resources corresponding to the first user group and automatically provides access permissions to the user to entity resources corresponding to the second user group. For example, when a user transitions from Finance to HR, the module revokes access to finance-specific resources and grants access to HR-specific resources. The permission management module 204 executes these permission updates through the API 122, providing changes are properly implemented across all entity resources regardless of their storage location in entity systems 150, third-party systems 140, or the central database system 110.

In some embodiments, the permission management module 204 automatically revokes the access permissions from the user to entity resources corresponding to the first user group by retrieving a set of resource identifiers for entity resources corresponding to the first user group from the database 220 (e.g., “FINANCE_DASHBOARD_001”, “BUDGET_TOOL_002”), determining current access permissions granted to the user for the entity resources (e.g., “READ_WRITE” access to finance dashboards), and removing the determined access permissions for each entity resource in the set of resource identifiers. For example, the permission management module 204 may revoke a former Finance Manager's “ADMIN” access to financial reporting tools and “READ_WRITE” access to budget approval systems.

In some embodiments, the permission management module 204 automatically provides the access permissions to the user to entity resources corresponding to the second user group by retrieving a set of resource identifiers for entity resources corresponding to the second user group from the database 220 (e.g., “HR_DASHBOARD_001”, “PERSONNEL_DB_002”), determining access permissions associated with the second user group for the entity resources (e.g., “FULL_ACCESS” to HR systems), and granting the determined access permissions to the user for each entity resource in the set of resource identifiers. For example, the permission management module 204 may grant a new HR Manager “ADMIN” access to personnel databases and “READ_WRITE” access to employee management systems.

The permission management module 204 maintains audit trails of all permission changes in the data store 116, recording details such as the resources affected, permissions modified, timestamps, and users involved. The permission management module 204 monitors these changes for any anomalies (e.g., unexpected bulk permission changes, unusual access patterns) that may require manual review by system administrators.

The control check module 208 detects and manages anomalous changes in group memberships and permissions. The control check module 208 monitors permission changes over time and calculates statistical measures, such as standard deviations in group membership changes, to identify significant variations. When the control check module 208 detects changes that exceed predefined thresholds (e.g., sudden increases or decreases in group size beyond a set percentage), it halts automated updates and flags the changes for manual review. The control check module 208 maintains historical data about group sizes and membership patterns to establish baselines for anomaly detection. The control check module 208 serves as a safety mechanism to prevent unauthorized or erroneous bulk permission changes, providing that significant modifications to access rights undergo appropriate administrative review before implementation.

The historical tracking module 210 tracks and maintains records of permission-related changes within the central database system 110. The historical tracking module 210 tracks historical data about role changes, group membership modifications, and permission updates, storing this information in the data store 116 with associated timestamps. The historical tracking module 210 maintains records of previous role assignments, group memberships, permission levels, access rights modifications, and the reasons for these changes. The historical data supports audit trails, provides permission history reviews, and provides context for the control check module 208 to detect anomalous changes. The historical data can be accessed through the reporting module 216 for compliance reporting and investigation of permission-related issues.

The workflow module 212 provides the end-to-end process of permission updates within the central database system 110. In some embodiments, the workflow module 212 implements directed acyclic graphs (DAGs) to manage workflow sequences, providing that permission-related tasks are executed in the correct order with proper dependencies. For example, when role changes are detected, the workflow module 212 coordinates actions across other modules, including triggering role identification, updating group mappings, modifying permissions, performing control checks, and logging changes. In some embodiments, the workflow module 212 provides that automated updates proceed only when control checks pass, and coordinates with the alert module 218 when manual intervention is required. Through the API 122, the workflow module 212 can orchestrates permission updates across all entity resources, regardless of whether they are stored in entity systems 150, third-party systems 140, or the central database system 110.

The validation module 214 verifies the accuracy and integrity of permission changes before they are implemented. The module validates that proposed permission changes align with organizational policies, checks for conflicts with existing permissions, and provides that all required data is present and properly formatted. When permission updates are initiated, the validation module 214 may perform these verification checks and only allows changes to proceed if all validation criteria are met. If validation fails, the validation module 214 coordinates with the alert module 218 to notify administrators of the issues requiring attention.

The reporting module 216 generates reports about access permissions and system activities using data from the data store 116. The reporting module 216 creates reports detailing role changes, permission modifications, group membership updates, and audit trails of administrative actions. It provides analytics about permission patterns, group sizes, and access trends over time to support administrative decision-making. The reporting module 216 can generate scheduled reports for regular review and on-demand reports for specific investigations or audits. These reports are accessible through the user interface module 118 and can be customized based on administrative requirements.

The alert module 218 notifies administrators of significant changes and anomalies detected in the permission management system. The alert module 218 generates alerts when the control check module 208 identifies unusual patterns in group membership changes, when the validation module 214 flags permission conflicts, or when manual review of automated changes is required. The alert module 218 can send notifications through the user interface module 118 and may integrate with external notification systems for timely administrator response. The alerts include relevant details about the detected issues, such as affected users, resources, and the nature of the changes requiring attention.

The database 220 is stored in the data store 116. The database 220 includes several data structures, including an entitlement dataset, a role database, a user group database, permission mappings, and configuration settings. The entitlement dataset stores role-to-group mappings with associated timestamps, metadata indicating whether role-to-group mappings are manually maintained or automatically inferred, and tracking of mapping changes. The role database includes information about available roles within entity systems 150, including role identifiers, descriptions, and hierarchies. The user group database maintains group definitions, memberships, and group hierarchies. The permission mappings define access rights and permitted operations for each user group on specific entity resources. The database 220 further includes configuration settings that define system parameters such as control check thresholds, validation rules, and workflow configurations for the access management module 114.

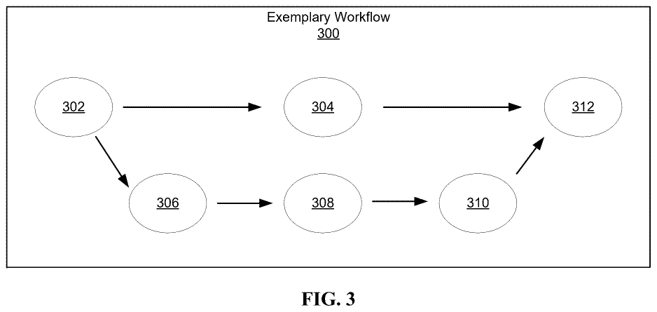

FIG. 3 shows an exemplary directed acyclic graph (DAG) workflow for permission management. The workflow module 212 can implement the workflow 300 shown in FIG. 3 by coordinating interactions across multiple modules and data components of the central database system 110. The workflow 300 is initiated when the role change detection module 206 detects changes in user roles and triggers the workflow module 212 to begin the permission update process. At Node 302, the workflow module 212 begins by interfacing with enterprise systems through the API 122 to gather updated user and organizational data, which it splits into two parallel processing streams.

For the first stream, the workflow module 212 transmits basic role data to Node 304, where it interfaces with the role identification module 200 and user group mapping module 202 to process immediate authentication and group membership updates. In the second stream, at Node 306, the workflow module 212 interfaces with the data store 116 to analyze role information and organizational hierarchies. The analyzed data flows to Node 308, where the workflow module 212 interfaces with the entitlement dataset stored in the database 220 to maintain timestamped role-to-permission mappings. At Node 310, the workflow module 212 interfaces with the validation module 214 and control check module 208 to verify and process permission changes, while filtering historical data maintained by the historical tracking module 210 to detect anomalous changes and ensure compliance with historical permission patterns.

The workflow concludes at Node 312, where the workflow module 212 interfaces with the permission management module 204 and the user interface module 118 to implement permission changes. The workflow module 212 also interacts with the logging module 120 to maintain audit trails in the data store 116, and triggers the alert module 218 when manual intervention is required. The permission management module 204 executes the final permission updates across all entity resources.

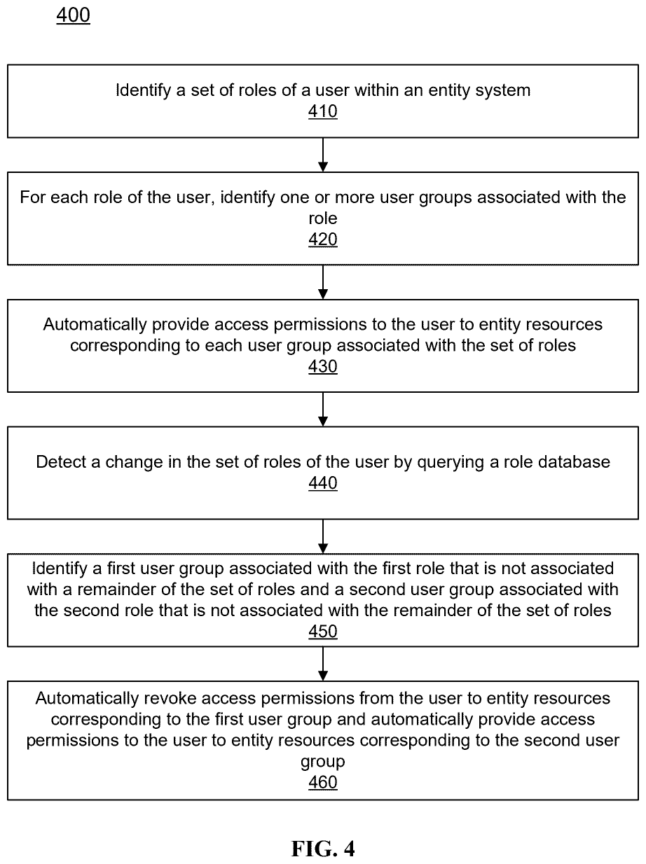

FIG. 4 is a flowchart illustrating a process 400 for permission management. A central database system identifies 410 a set of roles of a user within an entity system. The central database system queries a database (e.g., the entity database 112, the data store 116, or the database 220 in FIG. 1) to retrieve user data associated with the user, analyzes the user data to determine role data segments associated with the user, and selects the set of roles of the user within an entity system based on the role data segments. The central database system applies predefined logic rules to the role data segments and determines whether the role data segments satisfy criteria defined in the logic rules. Based on satisfied criteria, the central database system identifies the set of roles that correspond to satisfied criteria.

For each role of the user, the central database system identifies 420 one or more user groups associated with the role. The central database system maintains an entitlement dataset that maps roles to associated user groups. The central database system queries the entitlement dataset using role identifiers associated with each role of the user to retrieve user group associations for each role of the user. For example, the central database system maintains the entitlement dataset by storing timestamps associated with each role-to-group mapping, tracking changes to role-to-group associations over time, and maintaining historical records of role-to-group mappings. The central database system may identify a current timestamp and filters the entitlement dataset based on the current timestamp to retrieve current role-to-group mappings. The entitlement dataset includes role identifiers for each role in the entity system, group identifiers for each user group in the entity system, mapping data linking role identifiers to corresponding group identifiers, and metadata indicating whether each mapping is manually maintained or automatically inferred.

The central database system automatically provides 430 access permissions to the user to entity resources corresponding to each user group associated with the set of roles. In some embodiments, the central database system retrieves a set of resource identifiers associated with each user group from the database, determines access levels assigned to each user group for a corresponding entity resource, and grants each user access to the corresponding entity resource based on the determined access levels. The central database system determines the access levels assigned to each user group by maintaining an access dataset in the database. The access dataset maps the user groups to permitted operations on entity resources. Based on the user group mappings, the central database system can identify the permitted operations of each user group on a corresponding entity resource. In response to identifying the permitted operations, the central database system assigns access rights to each user group based on the permitted operations. The central database system executes permission updates on the entity resources by using an API, providing changes are properly implemented across all entity resources regardless of their storage location.

The central database system detects 440 a change in the set of roles of the user by querying a role database maintained in the database. The detected change can include a first role that is removed from the set of roles of the user and a second role that is added to the set of roles of the user. In some embodiments, the central database system receives a trigger event indicating a potential role change for the user. In response to receiving the trigger event, the central database system queries the role database to retrieve current role information for the user. In some embodiments, the central database system retrieves, from the role database, historical role information associated with the user, and compares the historical role information with current role information associated with the user. Responsive to the comparing, the central database system identifies the first role and the second role based on differences between the historical role information and the current role information. The central database system maintains audit trails of detected role changes in the database, and may initiate a permission update process when role changes are detected.

The central database system identifies 450 a first user group associated with the first role that is not associated with a remainder of the set of roles and a second user group associated with the second role that is not associated with the remainder of the set of roles. The central database system performs these identifications by analyzing the user group mappings. In some embodiments, the central database system identifies the first user group by maintaining a user group dataset that maps roles to associated user groups, querying the user group dataset to retrieve user groups mapped to the first role, and querying the user group dataset to retrieve user groups mapped to the remainder of the set of roles. The central database system then identifies the first user group as a user group that is mapped to the first role and not mapped to any role in the remainder of the set of roles. In a corresponding manner, the central database system identifies the second user group by maintaining the user group dataset, querying the user group dataset to retrieve user groups mapped to the second role, and querying the user group dataset to retrieve user groups mapped to the remainder of the set of roles. The central database system then identifies the second user group as a user group that is mapped to the second role and not mapped to any role in the remainder of the set of roles. Throughout this process, the central database system maintains audit trails of group identification activities in the databaase.

The central database system automatically revokes 460 access permissions from the user to entity resources corresponding to the first user group and automatically provides access permissions to the user to entity resources corresponding to the second user group. The central database system can execute these permission updates through an API, providing changes are properly implemented across all entity resources regardless of their storage location. In some embodiments, the central database system automatically revokes the access permissions from the user to entity resources corresponding to the first user group by retrieving a set of resource identifiers for entity resources corresponding to the first user group from the database, determining current access permissions granted to the user for the entity resources, and removing the determined access permissions for each entity resource in the set of resource identifiers. In some embodiments, the central database system automatically provides the access permissions to the user to entity resources corresponding to the second user group by retrieving a set of resource identifiers for entity resources corresponding to the second user group from the database, determining access permissions associated with the second user group for the entity resources, and granting the determined access permissions to the user for each entity resource in the set of resource identifiers. The central database system maintains audit trails of all permission changes in the database. The central database system can monitor the changes for any anomalies that might require manual review.

The figures depict various example embodiments of the present technology for purposes of illustration only. One skilled in the art will readily recognize from the following description that other alternative embodiments of the structures and methods illustrated herein may be employed without departing from the principles of the technology described herein.

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A computer-implemented method, comprising:
identifying, by a central database system, a set of roles of a user within an entity;
for each role of the user, identifying, by the central database system, one or more user groups associated with the role;
automatically providing, by the central database system, access permissions to the user to entity resources corresponding to each user group associated with the set of roles;
detecting, by the central database system, a change in the set of roles of the user by querying a role database maintained by the central database system, the detected change comprising a first role that is removed from the set of roles of the user and a second role that is added to the set of roles of the user;
identifying, by the central database system, a first user group associated with the first role that is not associated with a remainder of the set of roles and a second user group associated with the second role that is not associated with the remainder of the set of roles; and
automatically revoking, by the central database system, access permissions from the user to entity resources corresponding to the first user group and automatically providing, by the central database system, access permissions to the user to entity resources corresponding to the second user group.

2. The computer-implemented method of claim 1, wherein entity resources comprise one or more of: a dashboard associated with the user group, security credentials associated with the user group, a database associated with the user group, one or more tools or software, a distribution list associated with the user group, and one or more resources or systems external to the central database system.

3. The computer-implemented method of claim 1, wherein a user group comprises a set of users within the entity and wherein a role comprises a position or function of the user with regards to the user group.

4. The computer-implemented method of claim 1, wherein identifying the one or more user groups for each role of the user comprises:
maintaining an entitlement dataset that maps roles to associated user groups;
querying the entitlement dataset using role identifiers associated with each role of the user; and
in response to querying the entitlement dataset, retrieving user group associations for each role of the user.

5. The computer-implemented method of claim 1, wherein automatically providing access permissions to the user to entity resources comprises:
retrieving a set of resource identifiers associated with each user group;
determining access levels assigned to each user group for a corresponding entity resource; and
granting each user access to the corresponding entity resource based on the determined access levels.

6. The computer-implemented method of claim 5, wherein determining the access levels assigned to each user group comprises:
maintaining an access dataset mapping the user groups to permitted operations on the entity resources;
identifying the permitted operations of each user group on the corresponding entity resource; and
in response to identifying the permitted operations, assigning access rights to each user group based on the permitted operations.

7. The computer-implemented method of claim 1, wherein automatically providing access permissions to the user comprises providing access permissions without user input from the user or from another user associated with the central database system.

8. The computer-implemented method of claim 1, wherein detecting the change in the set of roles comprises applying a set of rules to characteristics associated with the user stored within the role database to identify an updated set of roles associated with the user.

9. The computer-implemented method of claim 1, wherein the role database is queried periodically or after the passage of a threshold interval of time.

10. The computer-implemented method of claim 1, wherein the access permissions corresponding to a user group are identified by querying an access permissions database that maps user groups to access permissions.

11. The computer-implemented method of claim 1, further comprising populating an interface with changes to a user group to identify one or more users added to the user group and one or more users removed from the user group.

12. The computer-implemented method of claim 11, wherein the changes to the user group are identified by querying user group membership logs.

13. The computer-implemented method of claim 1, further comprising populating an interface with changes to access permissions associated with the user.

14. The computer-implemented method of claim 1, wherein, in response to determining that a threshold number of threshold percentage of members are added to or removed from a user group, access permissions are not automatically revoked or provided for members of the user group.

15. A non-transitory computer-readable medium comprising memory with instructions encoded thereon, the instructions causing one or more processors to perform operations when executed, the instructions comprising instructions to:
identify, by a central database system, a set of roles of a user within an entity;
for each role of the user, identify, by the central database system, one or more user groups associated with the role;
automatically provide, by the central database system, access permissions to the user to entity resources corresponding to each user group associated with the set of roles;
detect, by the central database system, a change in the set of roles of the user by querying a role database maintained by the central database system, the detected change comprising a first role that is removed from the set of roles of the user and a second role that is added to the set of roles of the user;
identify, by the central database system, a first user group associated with the first role that is not associated with a remainder of the set of roles and a second user group associated with the second role that is not associated with the remainder of the set of roles; and
automatically revoke, by the central database system, access permissions from the user to entity resources corresponding to the first user group and automatically provide, by the central database system, access permissions to the user to entity resources corresponding to the second user group.

16. The non-transitory computer-readable medium of claim 15, wherein entity resources comprise one or more of: a dashboard associated with the user group, security credentials associated with the user group, a database associated with the user group, one or more tools or software, a distribution list associated with the user group, and one or more resources or systems external to the central database system.

17. The non-transitory computer-readable medium of claim 15, wherein a user group comprises a set of users within the entity and wherein a role comprises a position or function of the user with regards to the user group.

18. The non-transitory computer-readable medium of claim 15, wherein identifying the one or more user groups for each role of the user comprises:
maintaining an entitlement dataset that maps roles to associated user groups;
querying the entitlement dataset using role identifiers associated with each role of the user; and
in response to querying the entitlement dataset, retrieving user group associations for each role of the user.

19. The non-transitory computer-readable medium of claim 15, wherein automatically providing access permissions to the user comprises providing access permissions without user input from the user or from another user associated with the central database system.

20. A computer system comprising:
one or more processors; and
a non-transitory computer readable storage medium storing instructions that, when executed by the one or more processors, cause the one or more processors to perform operations comprising:
identifying, by a central database system, a set of roles of a user within an entity;
for each role of the user, identifying, by the central database system, one or more user groups associated with the role;
automatically providing, by the central database system, access permissions to the user to entity resources corresponding to each user group associated with the set of roles;
detecting, by the central database system, a change in the set of roles of the user by querying a role database maintained by the central database system, the detected change comprising a first role that is removed from the set of roles of the user and a second role that is added to the set of roles of the user;
identifying, by the central database system, a first user group associated with the first role that is not associated with a remainder of the set of roles and a second user group associated with the second role that is not associated with the remainder of the set of roles; and
automatically revoking, by the central database system, access permissions from the user to entity resources corresponding to the first user group and automatically providing, by the central database system, access permissions to the user to entity resources corresponding to the second user group.
